(19) United States
(12) Patent Application Publication
(10) Pub. No.: US 2026/0321123 A1
(43) Pub. Date: Oct. 15, 2026

(54) Electronic Indicia Carrying Construct System and Method for using the same

(71) Applicant: Arthur Eidelson, New Milford, CT (US)

(72) Inventor: Arthur Eidelson, New Milford, CT (US)

(21) Appl. No.: 19/466,374

(22) Filed: Jan. 31, 2026

Related U.S. Application Data
(60) Provisional application No. 63/752,665, filed on Feb. 1, 2025.
(60) Provisional application No. 63/784,438, filed on Apr. 7, 2025.

(51) Int. Cl. G08B 21/24; G08B 7/06; G08B 25/10

(52) U.S. Cl. CPC G08B 21/24; G08B 7/06; G08B 25/10

(57) ABSTRACT

An electronic indicia carrying construct and method provide a perceptible alarm substantially coincident with a predetermined absolute date and time. The construct comprises a flexible substrate carrying at least one independently addressable control circuit operatively coupled to at least one annunciator and at least one power source. A controller transmits a data stream to program alarm timing and annunciation behavior. The construct may be armed by removal of a pull tab or backing sheet and mounted to flat or contoured surfaces using an adhesive layer. Visual or audio alarms are generated at selected calendar dates and times.

### CROSS-REFERENCE TO RELATED APPLICATIONS

This application claims priority to and is a continuation of U.S. Provisional Application No. 63/752,665 filed Feb. 1, 2025 and U.S. Provisional Application No. 63/784,438 filed Apr. 7, 2025, the entire disclosures of which may be incorporated herein by reference in their entirety.

### FIELD OF THE INVENTION

One or more embodiments of the present invention relates broadly to time-based electronic reminder and signaling devices and methods for constructing and using the same. More particularly, one or more embodiments of the present invention relates to thin, flexible electronic indicia carrying constructs, also referred to herein as electronic labels, reminder devices, or indicative constructs, including smart strip lights, labels, cards, badges, and adhesive devices incorporating independently addressable control circuitry and real-time clock circuitry for providing perceptible alarms at predetermined absolute dates and times.

### BACKGROUND OF THE INVENTION

Smart strip lights may be flexible printed circuit boards containing embedded RGB or RGBW light emitting diodes arranged in a linear repeating format and used for accent, task, and decorative lighting. For example, a smart Strip Light is a flexible PCB (printed circuit board) that is usually black or white in color and contains embedded RGB (red, green, blue) or RGBW (red, green, blue, white) LEDs (light emitting diodes) placed in a linear repeating format. Smart strip lights have been used to create dynamic and complex ambient lighting effects, can be extended or trimmed down with a scissors to meet the needs of your space, often meet industrial standard IP65 for dust, water and other environmental factors, and often have an adhesive backing for easy mounting. An example of such technologies may be found in U.S. Pat. No. 6,337,836 B1.

Intelligently controlled light pixels typically include microcontroller circuitry or independent control circuitry integrated within the light emitting device package and permit independent control of color and brightness. For example, intelligently controlled LED light pixels (typically 30 pixels per meter) often have a control circuit ASIC (application specific integrated circuit) integrated within its RGB (red, green, blue) or RGBW (red, green, blue, white) LED package for controlling pixel color and brightness. The WS2812B and WS2815 light sources may be each a kind of intelligently controlled pulse width modulated RGB color and brightness LED pixels. Each RGB 5050 LED chip within the pixel has 256 levels of brightness. This results in over 16.7 million different colors that can be produced per pixel.

Newer lighting systems permit scheduling of color patterns at selected times of day and calendar dates. However, conventional systems generally synchronize all pixels or lack independent absolute date and time alarm capability.

For example, Smart Strip Lights may be typically programmed via a Smartphone application. Programming intricate LED pixel patterns can be made less tedious with software programs such as LEDEdit™ ƒrom Shenzhen Singba Light Technology Co., Ltd. or LEDEdit™ which primarily works with the Microsoft® Windows® operating system. These applications allow users to customize colors and brightness levels by selecting options within the application. However, newer software may allow the user to schedule LED color patterns at a specific time of day, day of week, and days of the year. Typically, specific times for different color schemes may be sent wirelessly from a Smartphone application to a WiFi® controller or Bluetooth® controller. The controller manages the settings of the LED strip light. In a preferred embodiment, the controller allows for individual control of LEDs which enable complex color transitions and effects across the strip light as long as the controller is attached.

Electronic indicia reminder devices may be label-like or card-like devices incorporating power sources, real-time clock circuits, and annunciators that provide a perceptible alarm when a predetermined absolute date and time occurs. In many industries tracking time intervals is an important function of manufacturing, or other areas where the shelf life of materials may be a concern. Often, critical dates and times may be tracked on a periodic basis by individuals over long time intervals.

In industries like the pharmaceutical industry, employees may be charged with monitoring the due dates for recalibration of critical instruments or machinery. This is also true in service providing industries. For example, doctors or dentists often want their patients to make a return visit after a specific interval of time has passed. In these cases the patient is charged with keeping track of the appointment date and time.

Prior reminder devices have been bulky, chemically imprecise, inaccurate over long intervals, or incapable of precise absolute time signaling. Self-expiring visitor badges provide security in places like schools, hospitals, and businesses by preventing badge reuse via a chemically induced perceptible signal such as a color shift or a “VOID” message appearing on the badge itself after an allotted time has elapsed. Self-expiring badges typically consist of a two-layer system utilizing red colored ink released from a back layer that seeps through to the front layer after activation. However, self-expiring badges may be not perfectly precise because chemical seepage is gradual, affected by ambient temperature and humidity, and occurs over a period of time rather than all at once. Therefore, these badges may change color or display the word “VOID” ahead of or after their official expiration date and time.

There remains a need for thin, flexible, low-power, highly accurate electronic indicia carrying constructs capable of independent control of turn-ON and turn-OFF time, programmable individually or in groups, and providing reliable perceptible alarms at predetermined absolute dates and times.

### SUMMARY OF THE INVENTION

It is an object of at least one embodiment disclosed herein to provide electronic indicia carrying constructs that provide perceptible alarms substantially coincident with predetermined absolute dates and times.

It is another object of at least one embodiment disclosed herein to provide constructs arranged on flexible substrates that may be programmed individually or substantially simultaneously and trimmed to detach selected quantities.

It is another object of at least one embodiment disclosed herein to provide independent control circuits embedded within each light emitting device or label permitting independent control of color, brightness, and turn-ON and turn-OFF timing.

It is another object of at least one embodiment disclosed herein to provide constructs incorporating highly accurate real-time clock circuits enabling long-term precision with ultra-low power consumption.

It is another object of at least one embodiment disclosed herein to provide constructs programmable by wired or wireless controllers and detachable after programming.

It is another object of at least one embodiment disclosed herein to provide constructs having adhesive backing, detachable backing sheets, pull tabs, dome switches, or cover sheets for arming and activation upon deployment.

It is therefore an object of at least one embodiment disclosed herein to provide a plurality of individually preprogrammed devices that each provide a perceptible alarm on the arrival or approach of a critical date, time, or both that is configured as a replacement for a specialized business card, appointment card, adhesive label, or self-expiring badge.

It is another object of at least one embodiment disclosed herein to provide a plurality of reminder devices on a strip from a flexible PCB populated by a plurality of annunciators, real time clock circuitry, power sources, and programming interfaces mounted in a repeating linear format.

It is yet another object of at least one embodiment disclosed herein that the plurality of reminder devices on a strip can be preprogrammed with the arrival or approach of a critical date, time, or both substantially simultaneously by the arrangement for programming.

It is also an object of at least one embodiment disclosed herein that the plurality of reminder devices on a strip be trimmable with a scissors to meet the quantity of preprogrammed reminder devices needed for any particular situation.

It is a further object of at least one embodiment disclosed herein that the plurality of reminder devices on a strip include human readable text or graphics printed thereon in a repeating linear format to facilitate the use of the electronic reminder devices as visual references.

It is still an object of at least one embodiment disclosed herein that the plurality of reminder devices on a flexible strip each have low power consumption to permit the reminder devices to operate over relatively long intervals of time.

It is another object of at least one embodiment disclosed herein that the plurality of reminder devices on a strip incorporate a highly accurate real time clock circuit so that the arrival or approach of critical dates, times, or both may be programmed substantially simultaneously as absolute dates and times rather than as an interval.

It is yet another object of at least one embodiment disclosed herein that the plurality of reminder devices on a strip may be configured as detachable thin flexible electronic labels that each provide a perceptible alarm on the arrival or approach of an absolute critical date, time, or both. Such electronic labels would have the attributes of the electronic reminder devices of at least one embodiment disclosed herein and additionally have an adhesive backing for easy mounting.

To those ends, a plurality of individually preprogrammed indicia carrying reminder devices include a flexible strip (substrate) populated by a plurality of annunciators, real time clock circuitry, power sources, and programming interfaces placed in a repeating linear format. The annunciators may be operatively connected to the real time clock circuits and provide perceptible alarms coincident with the predetermined dates and times. The indicia carrying devices further include programming interfaces operatively connected to the real time clock circuits whereby predetermined dates and time may be programmed substantially simultaneously by the arrangement for programming. The real time clock circuits, annunciators, and power sources may be preferably mounted to the strip in a repeating layered linear format.

According to at least one embodiment disclosed herein, real time clock circuitry of programmable electronic indicia carrying reminder devices may include a crystal controlled real time clock chip programmable to provide an alarm signal when a particular absolute date and time may be reached. One commercially available example of a real time clock of this type is Micro Crystal's RV8803, which contains a temperature compensated internal crystal and provides extremely precise time-keeping along with low power consumption. Current draw is typically 240 nA and the chip has a thickness of approximately 0.8 mm. In another embodiment disclosed herein, the real time clock circuit includes a single chip microcontroller that includes a real time clock as a feature. In still another embodiment, the real time clock circuits of programmable electronic indicia carrying reminder devices include ASICs (application specific integrated circuits). In another embodiment, the programmed absolute alarm time can be continuously modified based on embedded sensor data within the construct, for example, sensed temperature or humidity environmental conditions may be electrically detected and used to either increase or decrease the original pre-programmed absolute alarm time.

According to at least one embodiment disclosed herein, the power source for programmable electronic indicia carrying reminder devices preferably include either sheet-like, generally pliant batteries, button batteries, or printed batteries operatively connected to the real time clock circuits.

Exemplary annunciators preferably include visual indicators formed from generally pliant light emitting polymer sheets or chip LEDs. The light emitting polymer sheets or chip LEDs may be configured to provide visually perceptible alarms in response to the alarm signals to indicate that the predetermined dates and times have occurred. The visual indicators preferably include predetermined alarm messages that may be revealed in response to the alarm signals. It should be understood that many variations on the content of the alarm messages may be possible depending on the particular use of the reminder device and that at least one embodiment disclosed herein is not intended to be limited to any particular use or alarm message. Message revelations may include printed PTC (positive temperature coefficient) heater elements acting on irreversible thermochromic ink to permanently display the predetermined alarm messages without the use of a power source. Additionally, the annunciators may include audio generators that provide audible tones in response to the alarm signals.

According to at least one embodiment disclosed herein, the programmable interface of electronic indicia carrying reminder devices can be preprogrammed with the arrival or approach of a critical date, time, or both substantially simultaneously by the arrangement for programming. An application running on a Smartphone, personal computer, or tablet computer allows the user to select alarm and timer setup data that is sent wirelessly to a WiFi® timer controller or Bluetooth® timer controller. The timer controller is mechanically attached to the plurality of reminder devices on the flexible strip via an edge connector that passes alarm and timer data to the plurality of real time clock circuits substantially simultaneously thus allowing all the real time clocks to emit the alarm signals at their predetermined expiration dates and times. The real time clock circuitry manages the settings of the electronic indicia carrying reminder devices. Once programmed, the controller may be physically disconnected from the plurality of reminder devices on the strip and the strip can then be trimmed with a scissors to detach the quantity of preprogrammed reminder devices needed for any particular situation.

A plurality of individually preprogrammed electronic labels for providing signals at selectively predetermined dates and times may include a flexible label strip (substrate) populated by a plurality of annunciators, real time clock circuitry, power sources, and programming interfaces placed in a repeating linear format. The programming interfaces and annunciators of the electronic labels may be operatively connected to the real time clock circuits whereby predetermined dates and times may be programmed to provide perceptible alarms that may be substantially coincident with the predetermined dates and times. The real time clock circuits, annunciators, and power sources may be all preferably mounted to the strip in a repeating layered linear format. The electronic labels also may include an arrangement for attaching the programmable electronic labels to a surface.

The real time clock circuits of programmable electronic labels according to at least one embodiment disclosed herein preferably may include integrated circuit microcontrollers or ASICS (application specific integrated circuits).

According to at least one embodiment disclosed herein, the programmable interfaces of electronic labels on a strip can all be preprogrammed with the arrival or approach of a critical date, time, or both substantially simultaneously by the arrangement for programming. An application running on a Smartphone, personal computer, or tablet computer allows the user to select alarm and timer setup data that is sent wirelessly to a WiFi® timer controller or Bluetooth® timer controller. The timer controller is mechanically attached to the plurality of reminder labels on the flexible strip via a single edge connector that passes expiration date and time data to the plurality of real time clock circuits substantially simultaneously thus allowing all the real time clocks to produce alarm signals at the predetermined expiration dates and times. The real time clock circuitry manages the settings of the electronic labels. Once programmed, the timer controller may be physically disconnected from the plurality of reminder labels on the flexible strip and the strip can then be trimmed with a scissors to detach the quantity of preprogrammed reminder labels needed for any particular situation.

In yet another embodiment of at least one embodiment disclosed herein, an adhesive layer is added to the back sides of the programmable electronic labels. Peeling off backing paper creates a device that is sufficiently thin and flexible to permit application onto contoured surfaces such as the curved casing of an instrument.

In addition to or as an alternative of any other disclosed embodiment, an exemplary embodiment of a construct comprises a flexible electronic construct configured to generate a perceptible alarm at a predetermined absolute calendar date and time. The construct comprises at least one independently addressable control circuit operatively coupled to at least one annunciator and at least one power source. A controller communicates with the control circuit through a wired or wireless interface and transmits a data stream defining alarm timing and annunciation behavior, such that the control circuit activates the annunciator when maintained real-time clock data corresponds to programmed alarm data.

In addition to or as an alternative of any other disclosed embodiment, an exemplary embodiment of a construct further includes a surface configured to carry visually perceptible indicia, enabling the construct to function as an electronic label, badge, card, or similar indicia-bearing article providing both visual identification and time-based alarm signaling.

In addition to or as an alternative of any other disclosed embodiment, an exemplary embodiment of a construct comprises an annunciator including a visual indicator configured to provide a visually perceptible indication upon occurrence of the predetermined absolute date and time, thereby providing a visual alarm output to a user.

In addition to or as an alternative of any other disclosed embodiment, an exemplary embodiment of a construct comprises a visual indicator including one or more light emitting devices selected from single-color light emitting diodes, RGB light emitting diodes, RGBW light emitting diodes, polymer light emitting diodes, or organic light emitting diodes, enabling multicolor, brightness-controlled, or pattern-based alarm indications.

In addition to or as an alternative of any other disclosed embodiment, an exemplary embodiment of a construct comprises a visual indicator configured to reveal a predetermined message in response to the alarm signal, thereby providing a textual or symbolic visual indication when the alarm condition occurs.

In addition to or as an alternative of any other disclosed embodiment, an exemplary embodiment of a construct provides that the predetermined message is displayed permanently after activation without continued power consumption, thereby enabling irreversible indication of alarm occurrence for compliance, tracking, or record-keeping applications.

In addition to or as an alternative of any other disclosed embodiment, an exemplary embodiment of a construct provides that the predetermined message is revealed by a printed positive temperature coefficient heater element acting on irreversible thermochromic ink, such that localized heating permanently changes the visible state of the ink to reveal the message.

In addition to or as an alternative of any other disclosed embodiment, an exemplary embodiment of a construct comprises an annunciator including an audio generator configured to provide an audible alarm signal upon occurrence of the predetermined date and time.

In addition to or as an alternative of any other disclosed embodiment, an exemplary embodiment of a construct comprises an audio generator including a sound-emitting piezoelectric film configured to generate audible sound in response to an electrical drive signal from the control circuit.

In addition to or as an alternative of any other disclosed embodiment, an exemplary embodiment of a construct comprises an independently addressable control circuit including a real-time clock circuit configured to maintain absolute calendar time and to generate an alarm signal when stored alarm data matches maintained time data.

In addition to or as an alternative of any other disclosed embodiment, an exemplary embodiment of a construct provides that the real-time clock circuit is implemented using a microcontroller configured to maintain time registers and alarm registers and to control annunciator activation based on calendar time comparisons.

In addition to or as an alternative of any other disclosed embodiment, an exemplary embodiment of a construct provides that the real-time clock circuit is implemented as an application-specific integrated circuit configured to maintain absolute time and generate alarm signals with low power consumption and high long-term accuracy.

In addition to or as an alternative of any other disclosed embodiment, an exemplary embodiment of a construct provides that the real-time clock circuit is operatively coupled to the annunciator and configured to generate the alarm signal when an alarm register matches maintained real-time clock data, thereby providing precise calendar-based alarm activation.

In addition to or as an alternative of any other disclosed embodiment, an exemplary embodiment of a construct comprises a controller operatively coupled to a computing device through a wired or wireless interface and configured to receive at least one date, at least one time, and at least one of brightness data, color data, or sound data to generate a data stream for programming alarm behavior of the flexible construct.

In addition to or as an alternative of any other disclosed embodiment, an exemplary embodiment of a construct provides that the wireless interface comprises at least one of a Wi-Fi data link, a Bluetooth data link, an infrared data link, or a near-field communication data link, enabling short-range or network-based programming.

In addition to or as an alternative of any other disclosed embodiment, an exemplary embodiment of a construct provides that the computing device comprises a smartphone, tablet, personal computer, or wearable computing device, thereby enabling user programming through consumer or industrial platforms.

In addition to or as an alternative of any other disclosed embodiment, an exemplary embodiment of a construct provides independently addressable control of at least one of turn-ON time, turn-OFF time, illumination color, illumination brightness, or audio output, enabling individualized alarm behavior for multiple constructs or annunciators.

In addition to or as an alternative of any other disclosed embodiment, an exemplary embodiment of a construct is activated by arming the construct through sensing removal of a pull tab, backing sheet, or cover sheet to initiate current flow, maintaining real-time clock data in the control circuit, and activating an annunciator when maintained time data matches programmed alarm data.

In addition to or as an alternative of any other disclosed embodiment, an exemplary embodiment of a construct is mounted by peeling backing paper to expose an adhesive layer and attaching the construct to a flat or contoured surface, such that the construct remains operable to generate the alarm signal at the predetermined absolute date and time.

In addition to or as an alternative of any other disclosed embodiment, an exemplary embodiment of a construct comprises independently addressable control circuitry configured to provide independent addressable control of at least one of turn-ON time, turn-OFF time, illumination color, illumination brightness, or audio output, enabling programmable alarm behavior after attachment.

In addition to or as an alternative of any other disclosed embodiment, an exemplary embodiment of a construct comprises embedded sensor data configured to have its programmed absolute alarm time continuously modified based on embedded sensor data. In a specific example of this alternative, temperature or humidity environmental conditions may be used by the construct to either increase or decrease the original pre-programmed alarm absolute time.

### BRIEF DESCRIPTION OF THE DRAWINGS

FIG. 1 is a schematic diagram of a flexible electronic reminder device strip including a plurality of pixels, each pixel including an independent control circuit and an associated real-time clock circuit.

FIG. 2 is a schematic diagram illustrating wireless programming of the flexible electronic reminder device strip using a programming controller and a user application executing on a computing device.

FIG. 3 is a data transmission diagram illustrating an electronic reminder device data stream including sequential color data fields and sequential timing and alarm data fields for a plurality of pixel packages.

FIG. 4 is a timing diagram illustrating logic pulse widths and a refresh reset interval for data transmission in the electronic reminder device strip.

FIG. 5 is a schematic representation of a flexible electronic reminder device strip illustrating multiple independent control circuits and multiple distributed real-time clock circuits.

FIG. 6 is a perspective view of a stand-alone electronic reminder device configured as a badge, card, or label incorporating a real-time clock circuit, an annunciator, and a power source.

FIG. 7 is a front view of a reminder badge including a visible indicium and a light emitting diode configured to blink when an alarm time is reached.

In the drawings like characters of reference indicate corresponding parts in the different figures. The drawing figures, elements and other depictions should be understood as being interchangeable and may be combined in any like manner in accordance with the disclosures and objectives recited herein.

### DETAILED DESCRIPTION OF THE PREFERRED EMBODIMENTS

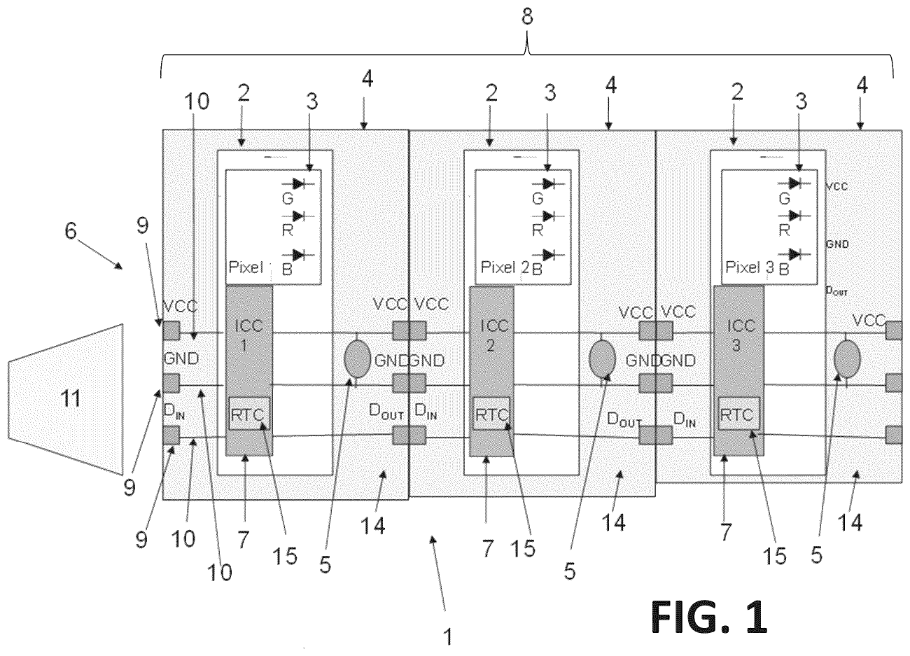

Turning now to the drawings and more particularly to FIG. 1, three programmable electronic indicia carrying reminder devices 4 according to one or more embodiments of the present invention may be illustrated generally at 1. The reminder devices 4 may be each mounted on a strip 8 from a flexible PCB board. The plurality of reminder devices 4 may be laid out in a repeating linear format across the flexible strip 8. As measured though its printing surface 14, the indicia carrying reminder devices 4 each have a thickness on the order of one-half to two millimeters, depending on the components used. The maximum thickness of the reminder devices 4 is dependent on the components used and is measured through either the ICC (Independent Control Circuitry) chip 7 or power source 5. This maximum thickness may vary from approximately one-half millimeter to approximately five millimeters. Each reminder device 4 contains real time clock circuitry 15, a power source 5, and an annunciator 2. Flexible strip 8 can be generally configured in the nature of a plurality of cards, labels, or badges that each provide a reminder or warning that a particular date and time of interest—hereinafter referred to as the critical date or expiration date—can be approaching or has been reached. When their critical dates may be reached, the plurality of reminder devices 4 each provide a perceptible alarm by blinking their annunciator 2 until its power source 5 can be drained. Blinking has the dual advantage of making the perceptible alarm more conspicuous while enhancing battery life. Once programmed, the strip 8 can be trimmed to detach the quantity of preprogrammed reminder devices needed for any particular situation. It will be understood by those skilled in the art that the plurality of reminder devices 4 laid out in a repeating linear format are only illustrative and not limited to three programmable electronic indicia carrying reminder devices. A higher or lower number of programmable electronic indicia carrying reminder devices may be used without departing from the scope and spirit of the invention.

Power sources 5 may be typically three volt lithium batteries formed as a flexible laminates having layers of anode and cathode materials separated by sheets of electrolyte. Commercially available batteries of this type having thicknesses on the order of 0.50 millimeters or less may be suitable for one or more embodiments of the present invention. It will be understood by those skilled in the art that other types of batteries may be used without departing from the scope and spirit of the invention. For example, printed batteries or thin button type batteries may be used. Also, all-plastic batteries or rechargeable batteries may be suitable. If non rechargeable batteries may be used, removal of a paper pull tab or acrylic pull tab located on each electronic reminder device can be used to initiate current flow. The paper pull tab or acrylic pull tab would be pulled by the end user prior to programming the electronic reminder device. If rechargeable batteries may be used, the reminder devices may be used over and over again. Recharging takes place while the reminder device can be connected to its timer controller.

In this preferred embodiment each annunciator 2 can be constructed with ICCs (independent control circuitry) 7 mounted inside their annunciator package. Annunciators also contain a green, red, and blue LED. ICCs (independent control circuitry) provides addressable independent control of the plurality of annunicators for turn ‘ON’ and turn ‘OFF’ time as well as color and brightness of the pixels 3. In this preferred embodiment the ICC (independent control circuitry) contains a real time clock circuit 15 which may contain an ASIC (application specific integrated circuit) or microcontroller. The low current consumption of the pixels 3 allow for direct drive by ICC (independent control circuitry) 7 with an approximately 330 ohm ⅛ watt resistor. It will be understood by those skilled in the art that other types of annunciators may be used without departing from the scope and spirit of the invention. For example, single chip LEDs (light emitting diodes), (PLEDs) polymer-based light emitting diodes, or small molecule based OLED (organic light emitting diodes) may be suitable.

As shown in FIG. 1 in this preferred embodiment, programming interface 6 contains electrical conductor pads 9 affixed to one surface of the strip 8. Conductor pads 9 deliver power through pads labeled Vcc and GND (Ground). Also, conductor pads 9 route data signals through pads labeled DIN (Data In) and DOUT (Data Out). Electrical conductor pads 9 may be electrically connected to each of the ICCs (independent control circuitry) 7 by the arrangement of electrical connection traces 10 printed on the flexible strip 8. Electrical conductor pads 9 may be arranged so that the programming interface 6 may be operatively connected to a timer controller 12 via edge connector 11.

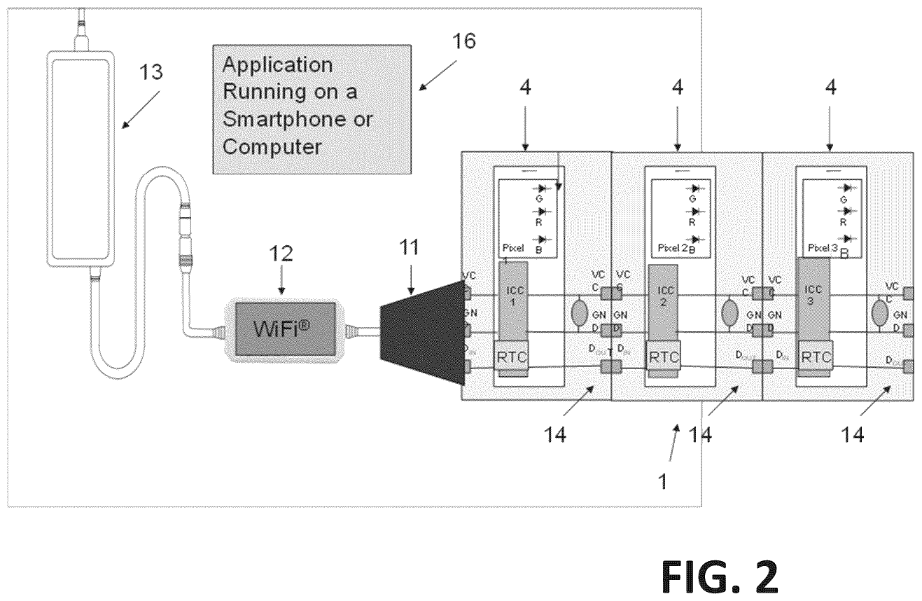

As shown in FIG. 2 in this preferred embodiment, an application 16 running on a Smartphone, personal computer, or tablet computer allows the user to select alarm, timer, and annunciator setup data that can be sent wirelessly to WiFi® timer controller 12 for programming electronic indicia carrying reminder devices 4. In this preferred embodiment WiFi® Timer Controller 12 utilizes a low-cost WiFi® microcontroller from Espressif Systems. It will be appreciated by those skilled in the art that many variations of wireless programming, such as Bluetooth®, an Infrared Data Association compliant infrared data link, or any other electromagnetic data link may be used for wireless programming without departing from the spirit and scope of one or more embodiments of the present invention.

As shown in FIG. 2 of this preferred embodiment, the ICCs (independent control circuitry) can be programmed through direct mechanical pad contact via edge connector 11 with WiFi® timer controller 12 using the communication protocol of the ICC (independent control circuitry). In this preferred embodiment, the programmed information includes color and brightness data for the RGB (red, green, blue) LEDs as well as the turn ‘ON’ and turn ‘OFF’ RGB (red, green, blue) LED time for each of the annunciators mounted on strip 8. Once programmed, the controller 12 may be physically disconnected from the plurality of reminder devices on the flexible strip 8 and the strip can be trimmed with a scissors to detach the quantity of preprogrammed reminder devices needed for any particular situation. Power Supply 13 typically plugs into a 120 VAC wall outlet and supplies the voltage required during programming time by the WiFi® timer controller 12 and strip 8.

Alternatively, any open-source electronics platform that allow users to build interactive projects such as Arduino® or Raspberry Pi® will interface via direct mechanical edge connector 11 with the reminder devices conductor's pads 9 for programming. However, other programming interface arrangements may be used. It will be understood by those skilled in the art that less complex programming devices may also be used.

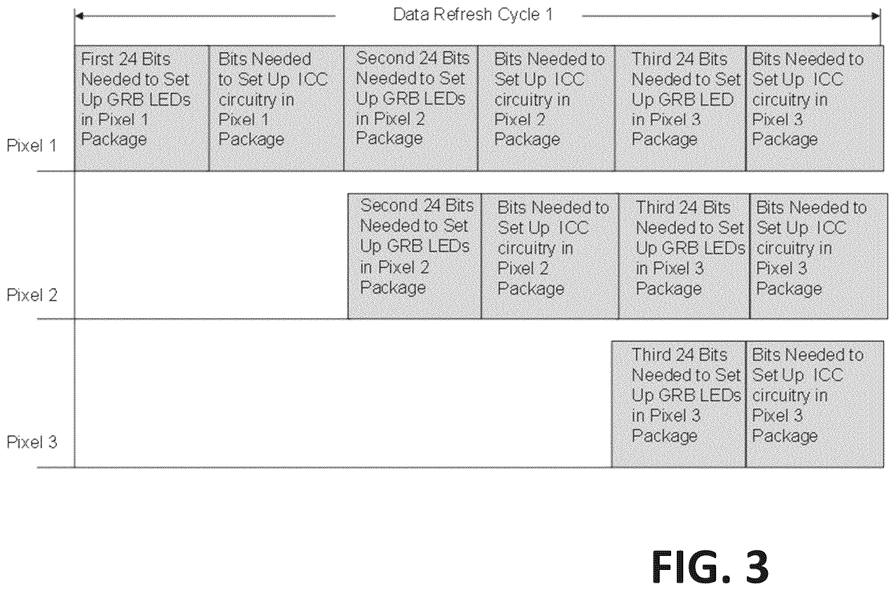

FIG. 3 illustrates a preferred embodiment of the data transmission stream for a plurality of indicia carrying reminder devices according to one or more embodiments of the present invention. The reminder devices ICC (independent control circuitry) 7 allow for control of color and brightness of the RGB LEDs as well as the turn on ‘ON’ and turn ‘OFF’ RGB (red, green, blue) LED time. As shown in FIG. 3, the first 24 bits received by the first ICC (independent control circuitry) may be used to set up color and brightness for RGB (red, green, blue) LEDs for pixel package 1. This can be followed by the bits required to set up the first ICC (independent control circuitry) for turn ‘ON’ and turn ‘OFF’ RGB LED time for pixel package 1. After these bits may be stripped out of the data stream by the first ICC (independent control circuitry), the second 24 bits received by the second ICC (independent control circuitry) may be used to set up color and brightness for RGB (red, green, blue) LEDs for pixel package 2. This can be followed by the bits required to set up the second ICC (independent control circuitry) for turn ‘ON’ and turn ‘OFF’ RGB LED time for pixel package 2. After these bits may be stripped out of the data stream by the second ICC (independent control circuitry), the next set of 24 bits can be used to set up the color and brightness RGB (red, green blue) LEDs for pixel package 3. This can be followed by the bits required to set up the third ICC (independent control chip) for turn ON′ and turn ‘OFF’ RGB LED time for pixel package 3. Finally, a low logic level greater than or equal to 300 microseconds resets the data transmission stream so that the ICC (independent control circuitry) know that its data can be going to be refreshed.

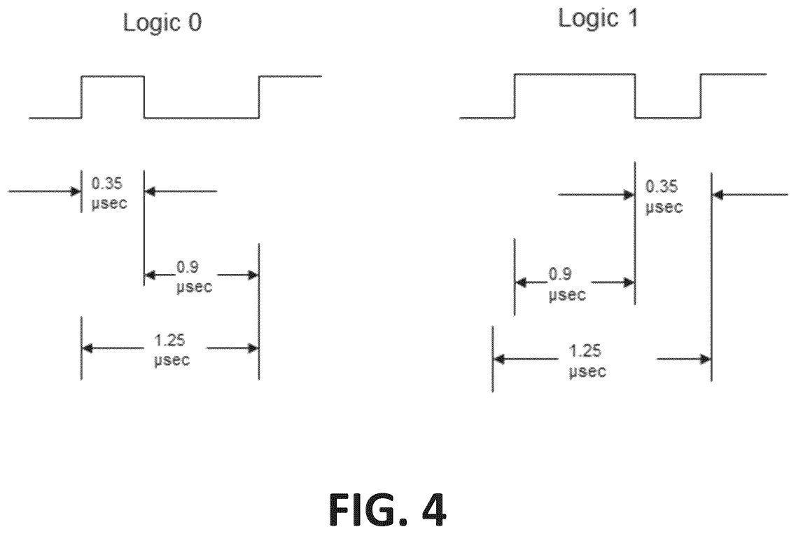

FIG. 4 illustrates timing for logic ‘0’ and logic ‘1’ bits in transmitted data streams used in programming electronic indicia carrying reminder devices. A logic ‘0’ consists of a 0.35 microsecond logic level high pulse followed by a 0.9 microsecond logic level low pulse. A logic ‘1’ consists of a 0.9 microsecond logic level high pulse followed by a 0.35 microsecond logic level low pulse. Finally, a low logic level greater than or equal to 300 microseconds resets the data transmission stream so that the ICC (independent control circuitry) knows that its data can be going to be refreshed. This process continues until all indicia carrying reminder devices have received the bits needed to program its color and brightness RGB (red, green, blue) as well as its turn ‘ON’ and turn ‘OFF’ RGB LED time. Additionally, each ICC (independent control chip) contains a signal reshaping and amplification circuit which ensures that waveform distortion does not accumulate as the data stream can be sent to the next ICC (independent control circuitry). Moreover, voltage drops cause by resistance in long electronic reminder device strips will have little effect on pixel color, brightness, or timing due to implementation of constant current control circuitry.

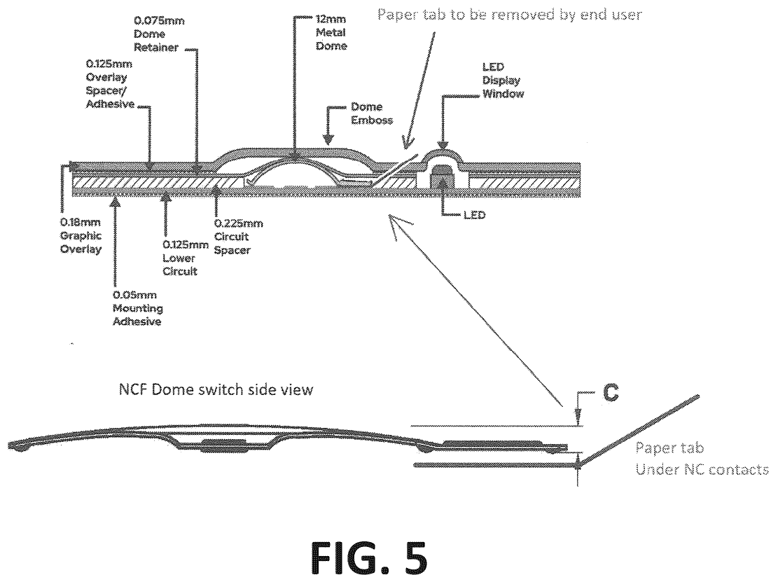

In yet another preferred embodiment as shown in FIG. 5, a normally closed dome membrane switch with an extended leg can be prevented from making contact with the dome's conductive footprint because of a paper pull tab or acrylic pull tab placed under its extended leg contact. Removal of the paper pull tab or acrylic pull tab by the end user causes the normally closed extended leg of the dome to make contact with its conductive footprint. This completes the circuit and allows current to flow, henceforth called arming a label. It will be appreciated by those skilled in the art that many variations of arming a label may be possible without departing from the spirit and scope of one or more embodiments of the present invention. Such variations may include but may be not limited to removal of an electronic reminder device from its backing paper or cover sheet. In another embodiment, removal of the pull tab may simply allow contact between conductive paths allowing current to flow without the need of a dome switch.

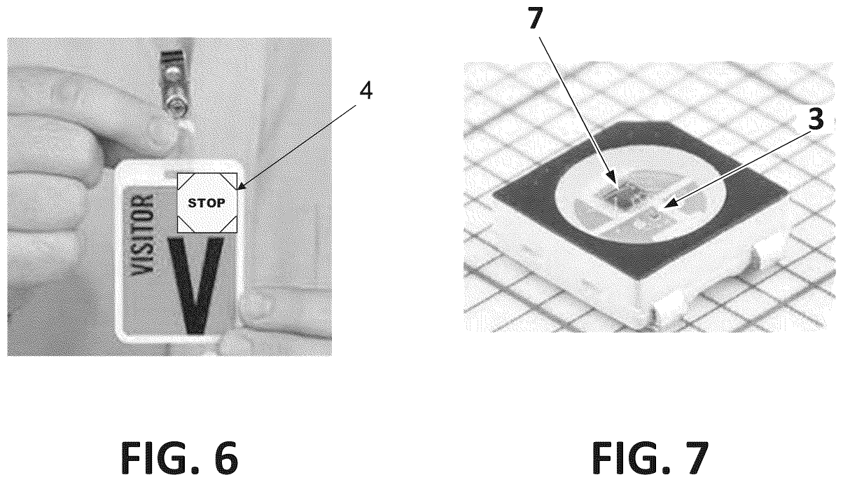

In yet another embodiment FIG. 6 shows a schematic representation of a reminder device attached to a public school visitor's day badge for enhanced security purposes. In this case no programming can be required as this label was preprogrammed during manufacturing to sense removal from its pull tab, thus arming the label resulting in the red portions of the stop sign blinking precisely seven hours later until the power source can be drained.

In one embodiment, each RGB or RGBW light emitting device package contains an embedded microcontroller and an independent control circuit permitting independent control of color, brightness, and turn-ON and turn-OFF time. Data streams transmitted along the flexible PCB provide sequential color data followed by timing data for each pixel, with signal reshaping and amplification preventing waveform degradation.

Logic timing pulses may be generated according to predetermined microsecond intervals, and a low-logic reset pulse refreshes the data stream. Backup data input lines may be provided to permit continued operation in the event of a break point.

In a further embodiment, a plurality of real-time clock circuits may be distributed along the flexible PCB such that each pixel or group of pixels can be associated with a corresponding real-time clock circuit. Each real-time clock circuit can be electrically coupled to a respective independent control circuit and provides absolute date and time reference information locally at each pixel location. Each pixel package can locally maintain time data with programmed alarm data to determine when to activate an associated annunciator.

Power, ground, data-in, and data-out conductors may be routed in parallel along the flexible PCB, and each independent control circuit strips data associated with its pixel before forwarding remaining data downstream.

A wireless programming controller may communicate with the flexible PCB through a wireless interface and deliver clock data and alarm data to each distributed real-time clock circuit.

The transmitted data stream may include sequential color data fields followed by sequential timing data fields, such that each pixel package receives data associated with that pixel before forwarding remaining data downstream. Logic waveforms and refresh intervals enable reliable absolute-time programming of multiple distributed reminder devices over a single serial bus.

In another embodiment, the system may include a stand-alone electronic reminder device incorporating a real-time clock circuit, at least one LED annunciator, and a compact power source. Such reminder devices may be worn, attached, or mounted and programmed to activate after a predetermined elapsed time or at a predetermined absolute date and time.

In another embodiment, the invention comprises programmable electronic labels including a multilayer substrate having a top indicia layer, a middle component layer, and a bottom conductor layer. The middle component layer may include a real-time clock integrated circuit, a power source, and at least one annunciator.

The bottom conductor layer may include conductor pads providing power, ground, clock, and data connections for programming. Power sources may include flexible printed batteries, rechargeable or non-rechargeable lithium batteries, laminated lithium cells, or printed energy storage devices.

Annunciators may include light emitting diodes, organic light emitting diode sheets, thermochromic displays, audio generators, or combinations thereof. Visual annunciators may display blinking lights or permanently revealed messages upon occurrence of an alarm event.

Programming may be performed by wired or wireless programming controllers using user applications executing on computing devices. Clock data and alarm data may be validated and transmitted to the real-time clock circuitry. Alarm testing may be performed by temporarily setting an alarm offset from the current time and monitoring annunciator response.

Each independent control circuit may be coupled to one or more sensors selected from accelerometers, temperature sensors, chemical sensors, strain gauges, humidity sensors, or pressure sensors. Sensor data may be processed locally to condition reminder activation on both temporal and sensed physical or chemical conditions.

The independent control circuit may include a micro-antenna and low-power radio transmitter configured to broadcast reminder signals to remote devices. Motion, temperature, chemical, and strain sensing may be used to trigger reminder or alarm functions based on threshold conditions. Sensor data may be stored locally and transmitted upon alarm activation or interrogation.

The independent control circuit may include a wireless communication interface supporting Bluetooth® Low Energy, Near Field Communication, Long Range Wide Area Network protocols, Ultra-Wideband, Zigbee®, Thread®, or equivalent radio technologies. Protocol selection may be based on communication range, power consumption, data rate, or localization requirements. Reminder activation may trigger immediate wireless transmissions to proximate or remote receivers.

The invention may further comprise a distributed reminder system including a plurality of reminder devices, wireless gateways, and at least one remote monitoring server. The remote monitoring server may store reminder schedules, alarm histories, sensor data, and device identifiers and provide notifications and reports to authorized users. The server may generate alerts, messages, or application notifications in response to reminder activation or abnormal conditions.

The independent control circuit may be implemented as a multi-layer microelectronic module including a control layer, a transceiver layer, and an amplification layer. Amplification circuitry may include power amplifiers and matching networks configured to amplify reminder signaling prior to radiation by an integrated micro-antenna.

The micro-antenna may be implemented as a printed trace antenna, patch antenna, loop antenna, or equivalent structure integrated within the flexible substrate.

Electronic labels may be armed by removal of a backing sheet, pull tab, or cover sheet permitting completion of an electrical circuit and initiation of current flow. Dome switches or spring contacts may complete the circuit upon arming of the device. Alternative arming mechanisms may include release of spring contacts or exposure of conductive paths.

Exemplary uses may include calibration reminders, security badges, appointment cards, maintenance reminders, and industrial monitoring devices. Electronic labels may be attached to flat or contoured surfaces using adhesive backing and removed after alarm activation.

In one embodiment, the light emitting devices comprises intelligently controlled LED light pixels including, by way of non-limiting example, WS2812B, WS2813, WS2815, SK9822, RGBIC devices, and functionally equivalent pixel packages incorporating embedded independent control circuitry, serial data interfaces, and internal waveform reshaping circuitry. Such intelligently controlled LED light pixels may include backup data input lines, fault-tolerant routing, internal oscillators, or internal timing generators and may be configured to receive color data, brightness data, and alarm timing data to provide both illumination and absolute-time reminder functions within a common pixel package.

In some embodiments, wireless communication and remote monitoring functions further may include integration with voice-assistant or home-automation platforms, including Apple Homekit®, Amazon Alexa®, Google Home®, smart speakers, home hubs, lighting controllers, security systems, building automation systems, or equivalent ecosystems, thereby enabling reminder activation, status queries, configuration, and alerts to be controlled or annunciated through voice commands or automation routines.

In further embodiments, programming and configuration of intelligently controlled LED light pixels may be performed using commercially available lighting control software, including by way of non-limiting example the LEDEdit program available from Shenzhen Singba Light Technology Co., Ltd., or functionally equivalent pixel-mapping and sequencing applications, such software be being configured to generate serial color data streams, pixel addressing data, timing data, and scheduling data, and to deliver such data to programming controllers or gateways for programming of the independent control circuits and associated real-time clock circuits.

In further embodiments, such programming and sequencing software may include, by way of non-limiting example, Madrix®, FastLED®, WLED®, xLights®, or equivalent open-source or commercial lighting control ecosystems, each being configured to generate pixel-addressed illumination data, animation data, pattern data, and time-based scheduling data, and to interface with controllers, gateways, or mobile devices for coordinated illumination and absolute-time reminder operation across one or more flexible constructs, strips, badges, or labels.

In further embodiments, communication between programming software, lighting controllers, gateways, and flexible constructs may be performed using one or more network lighting protocols selected from Digital Multiplex (“DMX”), Art-Net, Streaming ACN (“sACN”), Digital Addressable Lighting Interface (“DALI”), or functionally equivalent wired or wireless lighting control protocols, such protocols being configured to transport pixel addressing data, color data, brightness data, timing data, scheduling data, and alarm data between one or more controllers and a plurality of independently addressable control circuits.

In further embodiments, the invention comprises one or more lighting-controller hardware which may be devices including dedicated pixel controllers, lighting gateways, embedded microcontroller boards, single-board computers, industrial lighting controllers, or integrated smart-hub devices, each being configured to receive illumination and scheduling data from programming software or mobile applications and to distribute such data to a plurality of flexible constructs, strips, badges, or labels, and further to provide time synchronization, buffering, signal conditioning, amplification, and protocol conversion for coordinated absolute-time reminder and signaling operation.

In further embodiments, absolute time synchronization among controllers, gateways, mobile devices, servers, and independently addressable control circuits can be performed using one or more time-synchronization protocols selected from Network Time Protocol (“NTP”), Precision Time Protocol (“PTP”), Global Positioning System (“GPS”) time references, or equivalent wired or wireless time distribution mechanisms, such synchronization enabling coordinated alarm activation, drift compensation, cross-device scheduling, and deterministic timing across distributed lighting and reminder networks.

In further embodiments, the flexible constructs, controllers, gateways, and lighting devices may be arranged in mesh or multi-hop network topologies including Bluetooth® mesh, Zigbee® mesh, Thread® mesh, Wi-Fi® mesh, proprietary radio meshes, or hybrid wired-wireless meshes, each node being configured to relay illumination data, timing data, alarm data, status data, and synchronization data to neighboring nodes, thereby enabling scalable, fault-tolerant, and geographically distributed reminder and signaling networks.

In further embodiments, a plurality of lighting controllers, gateways, or smart hubs operate cooperatively in a multi-controller orchestration architecture in which scheduling data, pixel mapping data, timing data, alarm data, and synchronization data may be shared, replicated, load-balanced, or hierarchically distributed among multiple controllers, thereby enabling coordinated activation of annunciators, redundant control paths, failover operation, geographic partitioning, and large-scale orchestration of absolute-time reminder and illumination functions across buildings, campuses, industrial facilities, or infrastructure networks.

In further embodiments, security and authentication mechanisms may be provided to protect communication, configuration, and control of the independent control circuits, lighting controllers, gateways, mobile devices, and remote servers. Such mechanisms may include device authentication, mutual authentication, digital certificates, public-key or symmetric cryptography, secure boot, hardware be root-of-trust, message signing, encryption of data in transit and at rest, access control limits, role-based permissions, and secure provisioning, thereby preventing unauthorized programming, spoofing, tampering, replay attacks, or unauthorized activation of reminder and signaling functions.

In further embodiments, firmware be management and over-the-air (“OTA”) update mechanisms may be provided for the independent control circuits, lighting controllers, gateways, and associated devices, such mechanisms being configured to deliver firmware be images, configuration updates, security patches, protocol upgrades, and feature enhancements via wired or wireless links. Update procedures may include version control, cryptographic signature verification, rollback protection, staged deployment, partial updates, differential updates, redundancy images, and recovery modes, thereby enabling secure, reliable, and maintainable long-term operation of distributed reminder and lighting networks.

In further embodiments, quality-of-service (“QoS”) and latency control mechanisms may be provided to ensure determinations or bounded-latency delivery of timing data, alarm data, synchronization data, and control messages across wired or wireless networks. Such mechanisms may include traffic prioritization, time-sensitive networking, scheduling queues, bandwidth reservation, congestion control, jitter compensation, deadline enforcement, acknowledgment policies, retransmission limits, and adaptive rate control, thereby ensuring timely alarm activation, coordinated illumination, reliable polling, and predictable system behavior in safety-critical, industrial, or large-scale deployments.

In further embodiments, privacy, data-protection, and regulatory compliance mechanisms may be provided to protect personal, medical, biometric, location, and usage data generated by the independent control circuits, sensors, mobile devices, controllers, and servers. Such mechanisms may include data minimization, anonymization, pseudonymization, consent management, audit logging, retention controls, access controls, encryption, and policy enforcement in accordance with healthcare, safety, and data-protection regulations including, by way of non-limiting example, the Health Insurance Portability and Accountability Act (“HIPAA”), the General Data Protection Regulation (“GDPR”), the California Consumer Privacy Act (“CCPA”), and functionally equivalent privacy and compliance frameworks, thereby enabling lawful, secure, and auditable operation of reminder, monitoring, and safety systems.

In further embodiments, redundancy and high-availability architectures may be provided to ensure continuous operation of reminder, signaling, and monitoring functions in the presence of component failures, communication outages, or power interruptions. Such architectures may include redundant controllers, redundant gateways, mirrored servers, replicated databases, hot-standby nodes, active-active clusters, multi-path networking, watchdog timers, heartbeat monitoring, automatic failover, graceful degradation, and self-healing mechanisms, thereby enabling fault-tolerant, mission-critical deployment in healthcare, industrial, infrastructure, and safety applications.

In further embodiments, edge intelligence, machine learning, or anomaly-detection mechanisms may be provided at the independent control circuit, controller, gateway, or server to classify events, detect abnormal patterns, predict failures, or reduce false alarms. Such mechanisms may include threshold learning, pattern recognition, sensor fusion, statistical models, neural networks, confidence scoring, adaptive thresholds, drift detection, and on-device or edge inference, thereby enabling intelligent evaluation of motion events, thermal events, chemical events, location deviations, device health, and user behavior prior to generation of reminders, alarms, or escalations.

In further embodiments, battery management and energy-harvesting mechanisms may be provided to extend operational lifetime and reliability of the independent control circuits and associated devices. Such mechanisms may include battery state-of-charge estimation, state-of-health monitoring, adaptive duty-cycling, deep-sleep modes, load shedding, voltage regulation, supercapacitor buffering, and harvesting of energy from ambient light, vibration, motion, radio-frequency fields, thermal gradients, or inductive coupling, thereby enabling ultra-low-power operation, maintenance-free deployments, and long-duration monitoring in wearable, disposable, industrial, and infrastructure applications.

### Emergency Detection Polling and Pull Architecture

In a further embodiment, the independent control circuit (“ICC”) and associated sensors may be used in a polling, pull, or hybrid communication architecture to detect emergency, safety, or abnormal operating conditions and to notify a user, caregiver, enterprise system, or monitoring service. In this architecture, a mobile device, gateway, wearable device, vehicle system, or other remote node periodically or asynchronously requests sensor readings, derived parameters, alarm states, status flags, and identification data from the ICC via a wired or wireless interface.

The ICC may acquire, buffer, filter, and store raw sensor samples and computed metrics in local memory and respond to polling requests with current values, historical values, confidence indicators, and event counters, thereby enabling the remote node to evaluate safety conditions using local, edge, or cloud-based decision logic. Polling intervals, reporting granularity, and sleep schedules may be fixed, user-selectable, adaptive, duty-cycled, event-triggered, or power-aware based on battery state, motion state, location, time of day, risk profile, or prior sensor trends.

In one embodiment, a fall or impact event can be detected based on accelerometer, gyroscope, or inertial sensor data exhibiting a rapid change exceeding one or more predetermined thresholds. The ICC may compute fall indicators including peak acceleration, vector magnitude, jerk, free-fall duration, impact duration, posture change, orientation change, or recovery motion, and may generate a fall score, fall confidence value, or fall classification flag retrievable by the polling node or transmitted automatically upon detection.

In one embodiment, a fire, heat, or thermal emergency can be detected when temperature sensing circuitry measures a temperature, rate-of-rise, cumulative thermal dose, or resistance-based heat signature exceeding a safety threshold. The ICC may apply hysteresis, debounce windows, temporal averaging, or multi-sensor correlation and may set a thermal alarm flag, severity level, or escalation code that can be provided in response to a polling request or transmitted upon detection.

In one embodiment, a gas, vapor, smoke, or air-quality emergency can be detected when one or more chemical, electrochemical, gas, particulate, humidity, or acidity sensors produce values exceeding predetermined limits or trend thresholds. The ICC may compute concentration levels, exposure durations, toxicity indices, or quality scores and may generate corresponding alarm flags, hazard classifications, and time-stamped records retrievable by the polling node.

In one embodiment, a location or proximity safety condition can be evaluated by determining whether the ICC remains outside a designated safe zone, proximity boundary, geofence, beacon region, or anchor radius for a prolonged or cumulative period of time. Location or distance may be determined using one or more of Ultra-Wideband ranging, Bluetooth® proximity, received signal strength, time-of-flight, inertial dead-reckoning, NFC check-ins, satellite positioning, or hybrid localization techniques, and the ICC or polling node may generate wandering, separation, or elopement status indicators.

Threshold values, classification rules, timing windows, safe-zone definitions, escalation policies, acknowledgment requirements, and retry limits may be configured in the polling node, provisioned from a remote server, transmitted to the ICC for local evaluation, or applied dynamically at the polling node or server. In some embodiments, preliminary evaluation can be performed locally at the ICC and refined by the polling node or server, thereby enabling tiered decision architectures and reduced false alarms.

Upon determining that an emergency or safety condition exists, the polling node or ICC may initiate one or more actions including generation of a local audible, visual, or haptic alarm, transmission of alerts to a remote monitoring server, placement of voice or data calls, dispatch of push notifications, issuance of machine-to-machine messages, logging of compliance records, or initiation of escalation workflows to designated contacts, emergency services, or supervisory systems.

In another embodiment, the polling architecture can be integrated with the remote monitoring server embodiment such that polled ICC data, event records, classifications, and confidence metrics may be forwarded to the server, and the server applies multi-device correlation, temporal analytics, predictive models, or policy engines to generate alerts, prioritize responses, coordinate assistance, and provide dashboards, audit trails, and regulatory reporting across a population of monitored ICC devices.

Many further variations and modifications may suggest themselves to those skilled in art upon making reference to above disclosure and foregoing interrelated and interchangeable illustrative embodiments, which may be given by way of example only, and may be not intended to limit the scope and spirit of the interrelated embodiments of the invention described herein.

1. A device comprising:
a flexible construct having an upper surface and a lower surface, the upper surface being configured to provide at least one perceptible alarm signal at a predetermined absolute date and time, the construct comprising:
at least one independent control circuit disposed on the flexible construct and operatively coupled to at least one annunciator;
at least one power source electrically coupled to the at least one independently addressable control circuit and the at least one annunciator; and
a controller operatively coupled to the flexible construct through at least one wired or wireless communication interface and configured to transmit a data stream to the at least one independent control circuit to program alarm timing and annunciation behavior,
wherein the independent control circuit activates the annunciator to generate the alarm signal substantially coincident with the predetermined absolute date and time.

2. The device of claim 1, wherein the flexible construct includes a surface configured to carry visually perceptible indicia.

3. The device of claim 1, wherein the annunciator comprises a visual indicator configured to provide a visually perceptible indication when the predetermined absolute date and time occurs.

4. The device of claim 3, wherein the visual indicator comprises at least one of a single-color light emitting diode, an RGB light emitting diode, an RGBW light emitting diode, a polymer light emitting diode, or an organic light emitting diode.

5. The device of claim 3, wherein the visual indicator is configured to reveal a predetermined message in response to the alarm signal.

6. The device of claim 5, wherein the predetermined message is displayed permanently without continued power consumption after activation.

7. The device of claim 6, wherein the predetermined message is revealed by a printed positive temperature coefficient heater element acting on irreversible thermochromic ink.

8. The device of claim 1, wherein the annunciator comprises an audio generator configured to provide an audible alarm.

9. The device of claim 1, wherein the independent control circuit is configured to have a programmed absolute alarm time continuously modified based on one or more of temperature, humidity, or another environmental condition.

10. The device of claim 9, further comprising a real-time clock circuit.

11. The device of claim 10, wherein the real-time clock circuit comprises a microcontroller.

12. The device of claim 10, wherein the real-time clock circuit comprises an application-specific integrated circuit.

13. The device of claim 12, wherein the real-time clock circuit is operatively coupled to the annunciator and configured to generate the alarm signal when an alarm register matches maintained real-time clock data.

14. The device of claim 1, wherein the controller is operatively coupled to a computing device through at least one wired or wireless interface and is configured to receive at least one date, at least one time, and at least one of brightness data, color data, or sound data to generate the data stream for programming the flexible construct.

15. The device of claim 14, wherein the wireless interface comprises at least one of a Wi-Fi® data link, a Bluetooth® data link, an infrared data link, or a near-field communication data link.

16. The device of claim 14, wherein the computing device comprises a smartphone, tablet, personal computer, or wearable computing device.

17. The device of claim 1, wherein the independently addressable control circuit is configured to provide independent addressable control of at least one of turn-ON time, turn-OFF time, illumination color, illumination brightness, or audio output of the annunciator.

18. A method of activating an electronic indicia carrying construct to provide a perceptible alarm substantially coincident with a predetermined absolute date and time, comprising:
arming the construct by sensing removal of at least one of a pull tab, a backing sheet, or a cover sheet to initiate current flow to an independent control circuit; and
maintaining real-time clock data in the independent control circuit and activating an annunciator when maintained time data matches programmed alarm data.

19. The method of claim 18, further comprising:
peeling backing paper from the construct to expose an adhesive layer; and
attaching the construct to a flat or contoured surface such that the construct remains operable to generate the alarm signal at the predetermined absolute date and time.

20. The method of claim 19, wherein the electronic indicia carrying construct comprises independently addressable control circuitry configured to provide independent control of at least one of turn-ON time, turn-OFF time, illumination color, illumination brightness, or audio output of the annunciator.
